(19) United States
(12) Patent Application Publication
(10) Pub. No.: US 2019/0294428 A1
(43) Pub. Date: Sep. 26, 2019

(54) AUTOMATED SOFTWARE RELEASE DISTRIBUTION

(71) Applicant: CA, Inc., New York, NY (US)

(72) Inventors: Uri Scheiner, Sunnyvale, CA (US); Yaron Avisror, Kfar-Saba (IL); Gil Bleich, Karkur (IL)

(21) Appl. No.: 15/935,607

(22) Filed: Mar. 26, 2018

(51) Int. Cl. G06F 8/65; H04L 29/08

(52) U.S. Cl. CPC G06F 8/65; H04L 67/34

(57) ABSTRACT

A release combination including a plurality of software artifacts is generated. A first plurality of tasks on a validation server can be associated with a validation operation of the release combination. A second plurality of tasks on a production server can be associated with a production operation of the release combination. First data from execution of the first plurality of tasks with respect to the first release combination may be automatically collected. An automated execution of the first plurality of tasks on the validation server may be shifted to the second plurality of tasks on the production server responsive to a quality score of the release combination that is based on the first data.

### BACKGROUND

The present disclosure relates in general to the field of computer development, and more specifically, to automatically tracking and distributing software releases in computing systems.

Modern computing systems often include multiple programs or applications working together to accomplish a task or deliver a result. An enterprise can maintain several such systems. Further, development times for new software releases to be executed on such systems are shrinking, allowing releases to be deployed to update or supplement a system on an ever-increasing basis. In modern software development, continuous development and delivery processes have become more popular, resulting in software providers building, testing, and releasing software and new versions of their software faster and more frequently. Some enterprises release, patch, or otherwise modify software code dozens of times per week. As updates to software and new software are developed, testing of the software can involve coordinating the deployment across multiple machines in the test environment. When the testing is complete, the software may be further deployed into production environments. While this approach helps reduce the cost, time, and risk of delivering changes by allowing for more incremental updates to applications in production, it can be difficult for support to keep up with these changes and potential additional issues that may result (unintentionally) from these incremental changes. Additionally, the overall quality of a software product can also change in response to these incremental changes.

### SUMMARY

According to one aspect of the present disclosure, a release combination including a plurality of software artifacts is generated. A first plurality of tasks can be associated with a validation operation of the release combination. A second plurality of tasks can be associated with a production operation of the release combination. First data from execution of the first plurality of tasks with respect to the first release combination may be automatically collected. An automated execution of the first plurality of tasks may be shifted to the second plurality of tasks responsive to a quality score of the release combination that is based on the first data.

### BRIEF DESCRIPTION OF THE DRAWINGS

Other features of embodiments of the present disclosure will be more readily understood from the following detailed description of specific embodiments thereof when read in conjunction with the accompanying drawings, in which:

FIG. 1A is a simplified block diagram illustrating an example computing environment, according to embodiments described herein.

FIG. 1B is a simplified block diagram illustrating an example of a release combination that may be managed by the computing environment of FIG. 1A.

FIG. 2 is a simplified block diagram illustrating an example environment including an example implementation of a quality scoring system and release management system that may be used to manage the distribution of a release combination based on a calculated quality score, according to embodiments described herein

FIG. 3 is a schematic diagram of an example software distribution cycle of the phases of a release combination, according to embodiments described herein.

FIG. 4 is a schematic diagram of a release data model that may be used to represent a particular release combination, according to embodiments described herein.

FIG. 5 is a flow chart of operations for managing the automatic distribution of a release combination, according to embodiments described herein.

FIG. 6 is a flow chart of operations for calculating a quality score for a release combination, according to embodiments described herein.

FIG. 7 is a table including a collection of KPI values with example thresholds and weight factors, according to embodiments described herein.

FIG. 8 is a table including an example in which a first release combination Release A is compared to a second release combination Release B, according to embodiments described herein.

FIG. 9 is an example user interface illustrating an example dashboard that can be provided to facilitate analysis of the release combination, according to embodiments described herein.

FIG. 10 is an example user interface illustrating an example information graphic that can be displayed to provide additional information related to the release combination, according to embodiments described herein.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

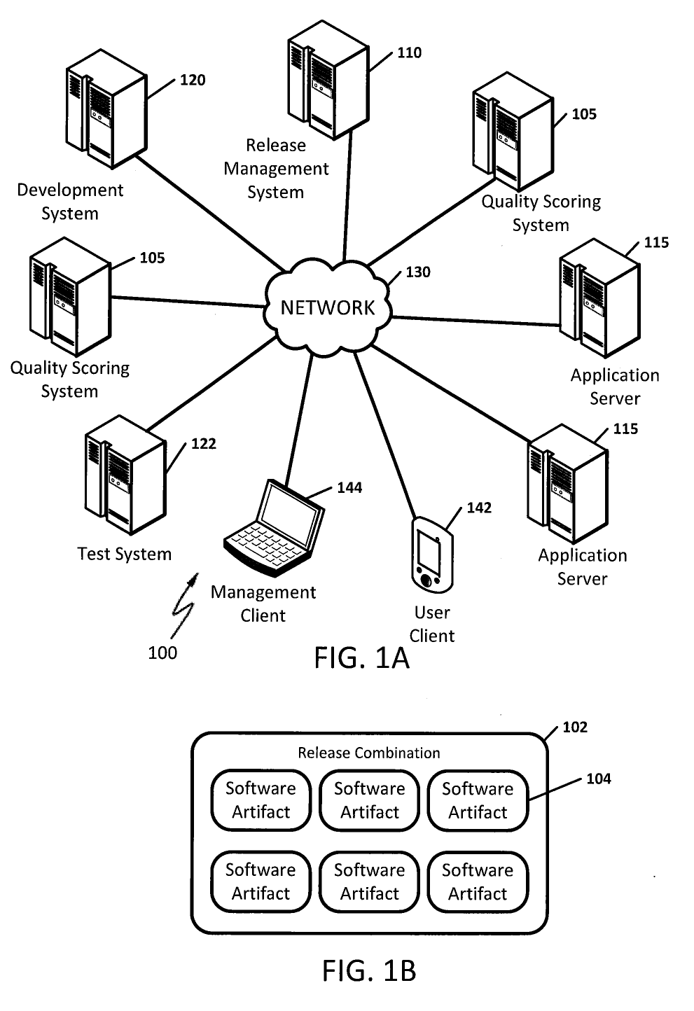

FIG. 1A is a simplified block diagram illustrating an example computing environment 100, according to embodiments described herein. FIG. 1B is a simplified block diagram illustrating an example of a release combination 102 that may be managed by the computing environment 100 of FIG. 1A, Referring to FIGS. 1A and 1B, the computing environment 100 may include one or more development systems (e.g., 120) in communication with network 130. Network 130 may include any conventional, public and/or private, real and/or virtual, wired and/or wireless network, including the Internet. The development system 120 may be used to develop one or more pieces of software, embodied by one or more software artifacts 104, from the source of the software artifact 104. As used herein, software artifacts (or “artifacts”) can refer to files in the form of computer readable program code that can provide a software application, such as a web application, search engine, etc., and/or features thereof. As such, identification of software artifacts as described herein may include identification of the files or binary packages themselves, as well as classes, methods, and/or data structures thereof at the source code level. The source of the software artifacts 104 may be maintained in a source control system which may be, but is not required to be, part of a release management system 110. The release management system 110 may be in communication with network 130 and may be configured to organize pieces of software, and their underlying software artifacts 104, into a combination of one or more software artifacts 104 that may be collectively referred to as a release combination 102. The release combination 102 may represent a particular collection of software which may be developed, validated, and/or delivered by the computing environment 100.

The software artifacts 104 of a given release combination 102 may be further tested by a test system 122 that, in some embodiments, is in communication with network 130. The test system 122 may validate the operation of the release combination 102. When and/or if an error is found in a software artifact 104 of the release combination 102, a new version of the software artifact 104 may be generated by the development system 120. The new version of the software artifact 104 may be further tested (e.g., by the test system 122). The test system 122 may continue to test the software artifacts 104 of the release combination 102 until the quality of the release combination 102 is deemed satisfactory. Methods for automatically testing combinations of software artifacts 104 are discussed in co-pending U.S. patent application Ser. No. ______ to Uri Scheiner and Yaron Avisror entitled “AUTOMATED SOFTWARE DEPLOYMENT AND TESTING” (Attorney Docket No. 1443-180278), the contents of which are herein incorporated by reference.

Once the release combination 102 is deemed satisfactory, the release combination 102 may be deployed to one or more application servers 115. The application servers 115 may include web servers, virtualized systems, database systems, mainframe systems and other examples. The application servers 115 may execute and/or otherwise make available the software artifacts 104 of the release combination 102. In some embodiments, the application servers 115 may be accessed by one or more user client devices 142. The user client devices 142 may access the operations of the release combination 102 through the application servers 115.

In some embodiments, the computing environment 100 may include one or more quality scoring systems 105. The quality scoring system 105 may provide a quality score for the release combination 102. In some embodiments, the quality score may be provided for the release combination 102 during testing and/or during production. That is to say that one quality score may be generated for the release combination 102 when the release combination 102 is being validated by the test system 122 and/or another quality score may be generated for the release combination 102 when the release combination 102 is deployed on the one or more application servers 115 in production. Methods for deploying software artifacts 104 to various environments are discussed in U.S. Pat. No. 9,477,454, filed on Feb. 12, 2015, entitled “Automated Software Deployment,” and U.S. Pat. No. 9,477,455, filed on Feb. 12, 2015, entitled “Pre-Distribution of Artifacts in Software Deployments,” both of which are incorporated by reference herein.

Computing environment 100 can further include one or more management client computing devices (e.g., 144) that can be used to allow management users to interface with resources of quality scoring system 105, release management system 110, development system 120, testing system 122, etc. For instance, management users can utilize management client device 144 to develop release combinations 102 and access quality scores for the release combinations 102 (e.g., from the quality scoring system 105).

In general, “servers,” “clients,” “computing devices,” “network elements,” “database systems,” “user devices,” and “systems,” etc. (e.g., 105, 110, 115, 120, 122, 142, 144, etc.) in example computing environment 100, can include electronic computing devices operable to receive, transmit, process, store, and/or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 110, 115, 120, 122, 142, 144, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, a quality scoring system 105, release management system 110, testing system 122, application server 115, development system 120, or other sub-system of computing environment 100 can be at least partially (or wholly) cloud-implemented, web-based, or distributed to remotely host, serve, or otherwise manage data, software services and applications interfacing, coordinating with, dependent on, or used by other services and devices in computing environment 100. In some instances, a server, system, subsystem, or computing device can be implemented as some combination of devices that can be hosted on a common computing system, server, server pool, or cloud computing environment and share computing resources, including shared memory, processor, and interfaces.

While FIG. 1A is described as containing or being associated with a plurality of elements, not all elements illustrated within computing environment 100 of FIG. 1A may be utilized in each embodiment of the present disclosure. Additionally, one or more of the elements described in connection with the examples of FIG. 1A may be located external to computing environment 100, while in other instances, certain elements may be included within or as a portion of one or more of the other described elements, as well as other elements not described in the illustrated implementation. Further, certain elements illustrated in FIG. 1A may be combined with other components, as well as used for alternative or additional purposes in addition to those purposes described herein.

Various embodiments of the present disclosure may arise from realization that efficiency in software development and release management may be improved and processing requirements of one or more computer servers in development, test, and/or production environments may be reduced through the use of an enterprise-scale release management platform across multiple teams and projects. The software release model of the embodiments described herein can provide end-to-end visibility and tracking for delivering software changes from development to production, may provide improvements in the quality of the underlying software release, and/or may allow the ability to track whether functional requirements of the underlying software release have been met. In some embodiments, the software release model of the embodiments described herein may be reused whenever a new software release is created so as to allow infrastructure for more easily tracking the software release combination through the various processes to production.

In some embodiments, the software release model may include the ability to dynamically track performance and quality of a software release combination both within the software testing processes as well as after the software release combination is distributed to production. By comparing software release combinations being tested (e.g., pre-production) to the performance and quality of a software release combination after production, the overall performance and functionality of subsequent releases may be improved.

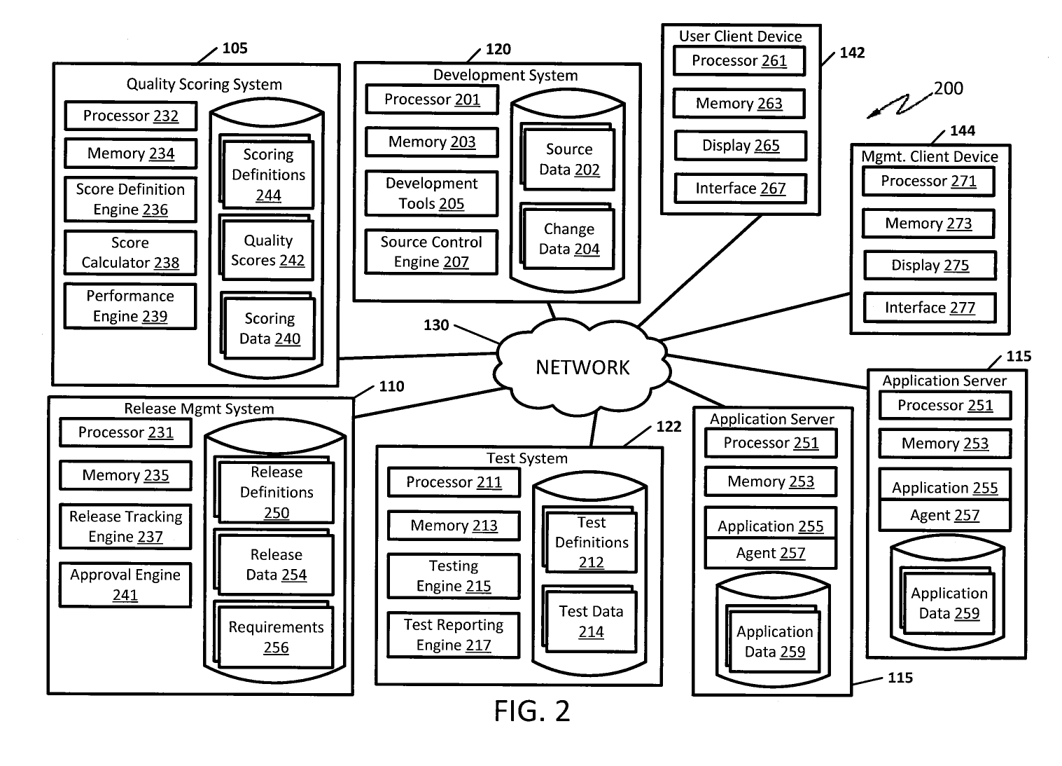

At least some of the systems described in the present disclosure, such as the systems of FIGS. 1A, 1B, and 2, can include functionality providing at least some of the above-described features that, in some cases, at least partially address at least some of the above-discussed issues, as well as others not explicitly described.

FIG. 2 is a simplified block diagram 200 illustrating an example environment that may be used to manage the distribution of a release combination 102 based on a calculated quality score, according to embodiments described herein. The example environment may include a quality scoring system 105 and release management system 110. In some embodiments, the quality scoring system 105 can include at least one data processor 232, one or more memory elements 234, and functionality embodied in one or more components embodied in hardware- and/or software-based logic. For instance, a quality scoring system 105 can include a score definition engine 236, score calculator 238, and performance engine 239, among potentially other components. Scoring data 240 can be generated using the quality scoring system 105 (e.g., using score definition engine 236, score calculator 238, and/or performance engine 239). Scoring data 240 can be data related to a particular release combination 102 that includes a set of software artifacts 104. In some embodiments, the scoring data 240 may include data specific to particular phases of the distribution of the release combination 102.

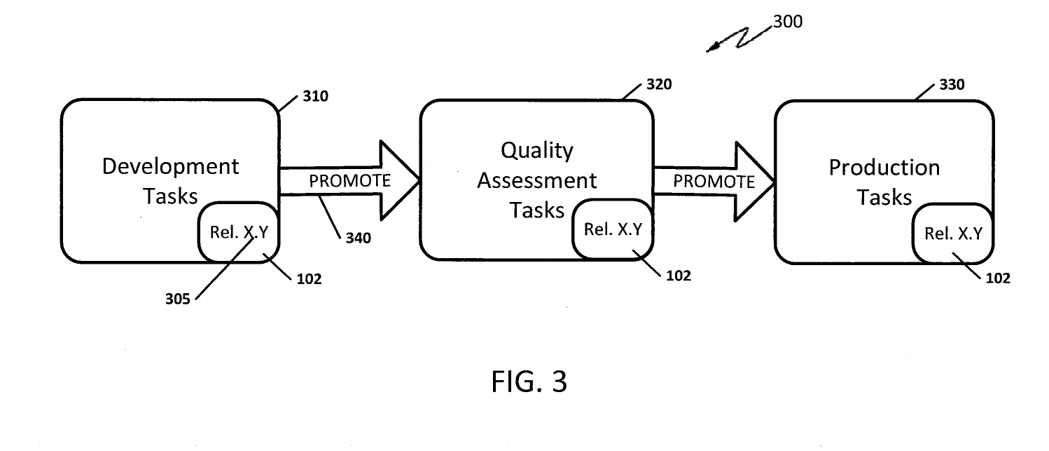

For example, FIG. 3 is a schematic diagram of an example software distribution cycle 300 of the phases of a release combination 102 according to embodiments described herein. Referring to FIG. 3, the software distribution cycle 300 for a particular release may have three phases. Though three phases are illustrated, it will be understood that the three phases are merely examples, and that more, or fewer, phases could be used without deviating from the embodiments described herein.

The three phases of the software distribution cycle 300 may include a development phase 310, a quality assessment (also referred to herein as a validation) phase 320, and a production phase 330. During each phase, one or more tasks may be performed on a particular release combination 102. In some embodiments, at least some of the tasks performed during one phase may be different than tasks performed during another phase. The release combination 102 may have a particular version 305, indicated in FIG. 3 as version X.Y, though this version is provided for example purposes only and is not intended to be limiting. When the operations of a particular phase (e.g., development phase 310) are completed, the release combination 102 may be promoted 340 to the next phase (e.g., quality assessment phase 320).

In some phases, the contents of the release combination 102 may be changed. That is to say that though the version number 305 of the release combination 102 may stay the same, the underlying object code may change. This may occur, for instance, as a result of defect fixes applied to the code during the various phases of the software distribution cycle 300.

In the development phase 310, development tasks may be performed on the release combination 102. For example, the code that constitutes the software artifacts 104 of the release combination 102 may be designed and built. Once development of the release combination 102 is complete, the release combination 102 may be promoted 340 to the next phase, the quality assessment phase 320.

The quality assessment phase 320 may include the performance of various tests against the release combination 102. The functionality designed during the development phase 310 may be tested to ensure that the release combination 102 works as intended. The quality assessment phase 320 may also provide an opportunity to perform validation tasks to test one or more of the software artifacts 104 of the release combination 102 with one another. Such testing can determine if there are interoperability issues between the various software artifacts 104. Once the quality assessment phase 320 is complete, the release combination 102 may be promoted 340 to the production phase 330.

The production phase 330 may include tasks to provide for the operation of the release combination within customer environments. In other words, during production, the release combination 102 may be considered functional and officially deployed to be used by customers. A release combination 102 that is in the production phase 330 may be generally available to customers (e.g., by purchase and/or downloading) and/or through access to application servers. In some embodiments, once the production phase 330 is achieved, the software distribution cycle 300 repeats for another release combination 102, in some embodiments using a different release version 305.

Promotion 340 from one phase to the next (e.g., from development to validation) may require that particular milestones be met. For example, to be promoted 340 from the development phase 310 to the quality assessment phase 320, a certain amount of the code of the release combination 102 may need to be complete to a predetermined level of quality. In some embodiments, to be promoted 340 from the quality assessment phase 320 to the production phase 330, a certain number of criteria may need to be met. For example, a predetermined number of test cases may need to be successfully executed. As another example, the performance of the release combination 102 may need to meet a predetermined standard before the release combination 102 can move to the production phase 330. The promotion 340, especially promotion from the quality assessment phase 320 to the production phase 330, may be a difficult step. In conventional environments, this can be a step requiring manual approval that can be time intensive and inadequately supported by data. Embodiments described herein may allow for the automatic promotion of the release combination 102 between phases of the software distribution cycle 300 based on a release model that is supported by data gathering and analysis techniques. As used herein, “automatic” and/or “automatically” refers to operations that can be taken without further intervention of a user.

Referring back to FIG. 2, the scoring data 240 of the quality scoring system 105 may include data that corresponds to particular phases of the software distribution cycle 300 of FIG. 3. In some embodiments, the scoring data 240 may include, for example, performance data related to the performance of the release combination 102 (e.g., during the quality assessment phase 320) and/or data related to the progress of the release combination 102 (e.g., during the quality assessment phase 320). Performance engine 239 may track the performance of a given release combination 102 during test and during production to generate the performance data that is a part of the scoring data 240. A quality score 242 may associated with the particular release combination 102. In some embodiments, the quality score 242 may be generated by the score calculator 238 based on the scoring data 240 and scoring definitions 244. The scoring definitions 244 may include information for calculating the quality scores 242 based on the scoring data 240. In some embodiments the scoring definitions 244 may be generated by, for example, the score definition engine 236.

As noted above, the quality scores 242 may be calculated for a given release combination 102. The release combination 102 may be defined and/or managed by the release management system 110. The release management system 110 can include at least one data processor 231, one or more memory elements 235, and functionality embodied in one or more components embodied in hardware- and/or software-based logic. For instance, release management system 110 may include release tracking engine 237 and approval engine 241. The release combination 102 may be defined by release definitions 250. The release definitions 250 may define, for example, which software artifacts 104 may be combined to make the release combination 102. The release tracking engine 237 may further generate release data 254. The release data 254 may include information tracking the progress of a given release combination 102, including the tracking of the movement of the various phases of the release combination 102 within the software development cycle 300 (e.g., development, validation, production). Movement from one phase (e.g., validation) to another phase (e.g., production) may require approvals, which may be tracked by approval engine 241. A particular release combination 102 may have goals and/or objectives that are defined for the release combination 102 that may be tracked by the release management system 110 as requirements 256. In some embodiments, the approval engine 241 may track the requirements 256 to determine if a release combination 102 may move between phases.

One such phase of a release combination 102 is development (e.g., development phase 310 of FIG. 3). During development, resources may be utilized to generate the software artifacts 104. The development process may be performed using one or more development systems 120. The development system 120 can include at least one data processor 201, one or more memory elements 203, and functionality embodied in one or more components embodied in hardware- and/or software-based logic. For instance, development system 120 may include development tools 205 that may be used to create software artifacts 104. For example, the development tools 205 may include compilers, debuggers, simulators and the like. The development tools 205 may act on source data 202. For example, the source data 202 may include source code, such as files including programming languages and/or object code. The source data 202 may be managed by source control engine 207, which may track change data 204 related to the source data 202. The development system 120 may be able to create the release combination and/or the software artifacts 104 from the source data 202 and the change data 204.

Another phase of the release combination 102 is validation and/or quality assessment (e.g., quality assessment phase 320 of FIG. 3). During validation, resources may be utilized to assess the quality of the release combination 102. The quality assessment process may be performed using one or more test systems 122. The test system 122 can include at least one data processor 211, one or more memory elements 213, and functionality embodied in one or more components embodied in hardware- and/or software-based logic. For instance, test system 122 may include testing engine 215 and test reporting engine 217. The testing engine 215 may include logic for performing tests on the release combination 102. For example, the testing engine 215 may utilize test definitions 212 (e.g., test cases) to generate operations which can test the functionality of the release combination 102 and/or the software artifacts 104. For instance, in some embodiments the testing engine 215 can initiate sample transactions to test how the release combination 102 and/or the software artifacts 104 respond to the inputs of the sample transactions. The inputs can be expected to result in particular outputs if the software functions correctly. The testing engine 215 can test the release combination 102 and/or the software artifacts 104 according to test definitions 212 that define how a testing engine 215 is to simulate the inputs of a user or client system to the release combination 102 and observe and validate responses of the release combination 102 to these inputs. The testing of the release combination 102 and/or the software artifacts 104 may generate test data 214 (e.g., test results) which may be reported by test reporting engine 217.

For testing and production purposes, the release combination 102 may be installed on, and/or interact with, one or more application servers 115. An application server 115 can include, for instance, one or more processors 251, one or more memory elements 253, and one or more software applications 255, including applets, plug-ins, operating systems, and other software programs that might be updated, supplemented, or added as part of the release combination 102. Some release combinations 102 can involve updating not only the executable software, but supporting data structures and resources, such as a database. One or more software applications 255 of the release combination 102 may further include an agent 257. In some embodiments, the agent 257 may be code and/or instructions that are internal to the application 255 of the release combination 102. In some embodiments, the agent 257 may include libraries and/or components on the application server 115 that are accessed or otherwise interacted with by the application 255. The agent 257 may provide application data 259 about the operation of the application 255 on the application server 115. For example, the agent 257 may measure the performance of internal operations (e.g., function calls, calculations, etc.) to generate the application data 259. In some embodiments, the agent 257 may measure a duration of one or more operations to gauge the responsiveness of the application 255. The application data 259 may provide information on the operation of the software artifacts 104 of the release combination 102 on the application server 115.

As indicated in FIG. 2, the release combination 102 may be installed on more than one application server 115. For example, the release combination 102 may be installed on a first application server 115 during a quality assessment process, and test operations (e.g., test operations coordinated by test system 122) may be performed against the release combination 102. The release combination 102 may also be installed on a second application server 115 during production. During production, the application server may be accessed by, for example, user client device 142. Thus, the application data 259 may include application data 259 corresponding to testing operations as well as application data 259 corresponding to production operations. In some embodiments, the application data 259 may be used by the performance engine 239 and score calculator 238 of the quality scoring system 105 to calculate a quality score 242 for the release combination 102.

During production, the release combination 102 may be accessed by one or more user client devices 142. User client device 142 can include at least one data processor 261, one or more memory elements 263, one or more interface(s) 267 and functionality embodied in one or more components embodied in hardware- and/or software-based logic. For instance, user client device 142 may include display 265 configured to display a graphical user interface which allows the user to interact with the release combination 102. For example, the user client device 142 may access application server 115 to interact with and/or operate software artifacts 104 of the release combination 102. As discussed herein, the performance of the release combination 102 during the access by the user client device 142 may be tracked and recorded (e.g., by agent 257).

In addition to user client devices 142, management client devices 144 may also access elements of the infrastructure. Management client device 144 can include at least one data processor 271, one or more memory elements 273, one or more interface(s) 277 and functionality embodied in one or more components embodied in hardware- and/or software-based logic. For instance, management client device 144 may include display 275 configured to display a graphical user interface which allows control of the operations of the infrastructure. For example, in some embodiments, management client device 144 may be configured to access the quality scoring system 105 to view quality scores 242 and/or define quality scores 242 using the score definition engine 236. In some embodiments, the management client device 144 may access the release management system 110 to define release definitions 250 using the release tracking engine 237. In some embodiments, the management client device 144 may access the release management system 110 to provide an approval to the approval engine 241 related to particular release combinations 102. In some embodiments, the approval engine 241 of the release management system 110 may be configured to examine quality scores 242 for the release combination 102 to provide the approval automatically without requiring access by the management client device 144.

It should be appreciated that the architecture and implementation shown and described in connection with the example of FIG. 2 is provided for illustrative purposes only. Indeed, alternative implementations of an automated software release distribution system can be provided that do not depart from the scope of the embodiments described herein. For instance, one or more of the score definition engine 236, score calculator 238, performance engine 239, release tracking engine 237, and/or approval engine 241 can be integrated with, included in, or hosted on one or more of the same, or different, devices as the quality scoring system 105. Thus, though the combinations of functions illustrated in FIG. 2 are examples, they are not limiting of the embodiments described herein. The functions of the embodiments described herein may be organized in multiple ways and, in some embodiments, may be configured without particular systems described herein such that the embodiments are not limited to the configuration illustrated in FIGS. 1A and 2. Similarly, though FIGS. 1A and 2 illustrate the various systems connected by a single network 130, it will be understood that not all systems need to be connected together in order to accomplish the goals of the embodiments described herein. For example, the network 130 may include multiple networks 130 that may, or may not, be interconnected with one another.

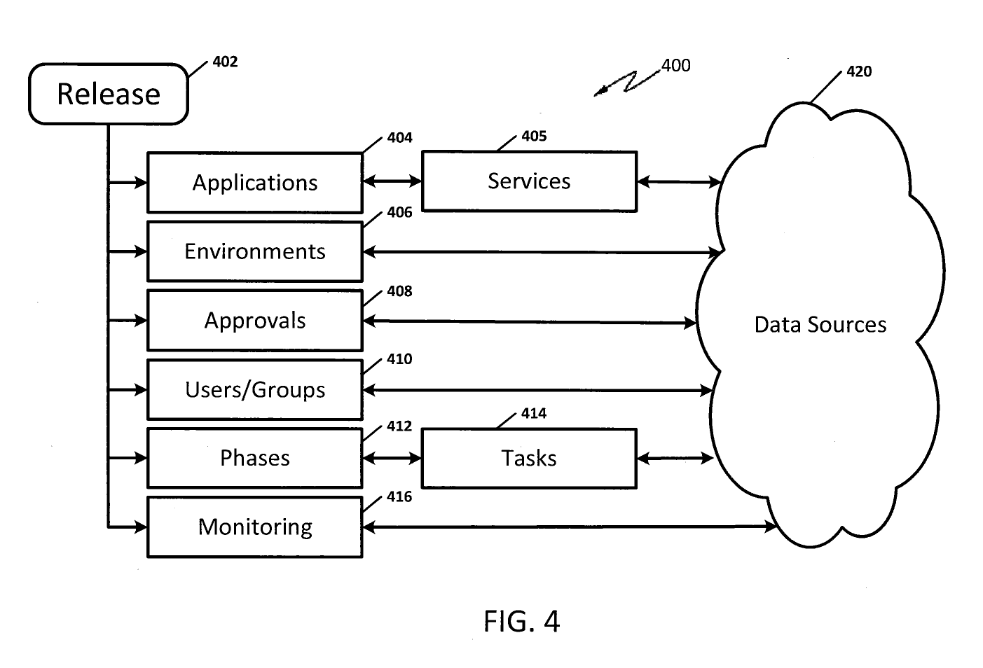

FIG. 4 is a schematic diagram of a release data model 400 that may be used to represent a particular release combination 102, according to embodiments described herein. As illustrated in FIG. 4, a release data model 400 may include a release structure 402. The release structure 402 may include a number of elements and/or operations associated with the release structure 402. The elements and/or operations may provide information to assist in implementing and tracking a given release combination 102 through the phases of a software distribution cycle 300. In some embodiments, each release combination 102 may be associated with a respective release structure 402 to facilitate development, tracking, and production of the release combination 102.

The use of the release structure 402 may provide a reusable and uniform mechanism to manage the release combination 102. The use of a uniform release data model 400 and release structure 402 may provide for a development pipeline that can be used across multiple products and over multiple different periods of time. The release data model 400 may make it easier to form a repeatable process of the development and distribution of a plurality of release combinations 102. The repeatability may lead to improvements in quality in the underlying release combinations 102, which may lead to improved functionality and performance of the release combination 102.

Referring to FIG. 4, release structure 402 of the release data model 400 may include an application element 404. The application element 404 may include a component of the release structure 402 that represents a line of business in the customer world. The application element 404 may be a representation of a logical entity that can provide value to the customer. For example, one or more application elements 404 associated with the release structure 402 may be associated with a payment system, a search function, and/or a database system, though the embodiments described herein are not limited thereto.

The application element 404 may be further associated with one or more service elements 405. The service element 405 may represent a technical service and/or micro-service that may include technical functionality (e.g., a set of exposed APIs) that can be deployed and developed independently. The services represented by the service element 405 may include functionalities used to implement the application element 404.

The release structure 402 of the release data model 400 may include one or more environment elements 406. The environment element 406 may represent the physical and/or virtual space where a deployment of the release combination 102 takes place for development, testing, staging, and/or production purposes. Environments can reside on-premises or within a virtual collection of computing resources, such as a computing cloud. It will be understood that there may be different environments elements 406 for different ones of phases of the software distribution cycle 300. For example, one set of environment elements 406 (e.g., including the test systems 122 of FIG. 2) may be used for the quality assessment phase 320 of the software distribution cycle 300. Another set of environment elements 406 (e.g., including an application server 115 of FIG. 2) may be used for the production phase 330 of the software distribution cycle 300. In some embodiments, different release combinations 102 may utilize different environment elements 406. This may correspond to functionality in one release combination 102 that requires additional and/or different environment elements 406 than another release combination 102. For example, one release combination 102 may require a server having a database, while another release combination 102 may require a server having, instead or additionally, a web server. Similarly, different versions of a same release combination 102 may utilize different environment elements 406, as functionality is added or removed from the release combination 102 in different versions.

The release structure 402 of the release data model 400 may include one or more approval elements 408. The approval element 408 may provide a record for tracking approvals for changes to the release combination 102 represented by the release structure 402. For example, in some embodiments, the approval elements 408 may represent approvals for changes to content of the release combination 102. For example, if a new application element 404 is to be added to the release structure 402, an approval element 408 may be created to approve the addition. As another example, an approval element 408 may be added to a given release combination 102 to move/promote the release combination 102 from one phase of the software distribution cycle 300 to another phase. For example, an approval element 408 may be added to move/promote a release combination 102 from the quality assessment phase 320 to the production phase 330. That is to say that once the tasks performed during the quality assessment phase 320 have achieved a desired result, an approval element 408 may be generated to begin performing the tasks associated with the production phase 330 on the release combination 102. In some embodiments, creation of the approval element 408 may include a manual process to enter the appropriate approval element 408 (e.g., using management client device 144 of FIG. 2). In some embodiments, as described herein, the approval element 408 may be created automatically. Such an automatic approval may be based on the meeting of particular criteria, as will be described further herein.

The release structure 402 of the release data model 400 may include one or more user/group elements 410. The user/group element 410 may represent users that are responsible for delivering the release combination 102 from development to production. For example, the users may include developers, testers, release managers, etc. The users may be further organized into groups (e.g., scrum members, test, management, etc.) for ease of administration. In some embodiments, the user/group element 410 may include permissions that define the particular tasks that a user is permitted to do. For example, only certain users may be permitted to interact with the approval elements 408.

The release structure 402 of the release data model 400 may include one or more phase elements 412. The phase element 412 may represent the different stages of the software distribution cycle 300 that the release combination 102 is to go through until it arrives in production. In some embodiments, the phase elements 412 may correspond to the different phases of the software distribution cycle 300 illustrated in FIG. 3 (e.g., development phase 310, quality assessment phase 320, and/or production phase 330), though the embodiments described herein are not limited thereto. The phase element 412 may further include task elements 414 associated with tasks of the respective phase. The tasks of the task element 414 may include the individual operations that can take place as part of each phase (e.g., Deployment, Testing, Notification, etc.), In some embodiments, the task elements 414 may correspond to the tasks of the different phases of the software distribution cycle 300 illustrated in FIG. 3 (e.g., development tasks of the development phase 310, quality assessment tasks of the quality assessment phase 320, and/or production tasks of the production phase 330), though the embodiments described herein are not limited thereto.

The release structure 402 of the release data model 400 may include one or more monitoring elements 416. The monitoring elements 416 may represent functions within the release data model 400 that can assist in monitoring the quality of a particular release combination 102 that is represented by the release structure 402. In some embodiments, the monitoring element 416 may support the creation, modification, and/or deletion of Key Performance Indicators (KPIs) as part of the release data model 400. When a release data model 400 is instantiated for a given release combination 102, monitoring elements 416 may be associated with KPIs to track an expectation of performance of the release combination 102. In some embodiments, the monitoring elements 416 may represent particular requirements (e.g., thresholds for KPIs) that are intended to be met by the release combination 102 represented by the release structure 402. In some embodiments, different monitoring elements 416 may be created and associated with different phases (e.g., quality assessment vs. production) to represent that different KPIs may be monitored during different phases of the software distribution cycle 300. In some embodiments the monitoring may occur after a particular release combination 102 is promoted to production. That is to say that monitoring of, for example, performance of the release combination 102 may continue after the release combination 102 is deployed and being used by customers.

The monitoring element 416 may allow for the tracking of the impact a particular release combination 102 has on a given environment (e.g., development and/or production). In some embodiments, one KPI may indicate a number of release warnings for a given release combination 102. For example, a release warning may occur when a particular portion of the release combination 102 (e.g., a portion of a software artifact 104 of the release combination 102) is not operating as intended. For example, as illustrated in FIG. 2, an application of a release combination 102 may incorporate internal monitoring (e.g., via agent 257) to monitor a runtime performance of the release combination 102. The internal monitoring may indicate that a runtime performance of the release combination 102 does not meet a predetermined threshold. The internal monitoring may be based on a performance template associated with the release combination 102. The performance template may define particular performance parameters of the release combination and, in some embodiments, define threshold values for these performance parameters. For example, a particular API may be monitored to determine if it takes longer to execute than a predetermined threshold of time. As another example, a response time of a portion of a graphical interface of the release combination 102 may be monitored to determine if it achieves a predetermined threshold. When the predetermined thresholds are not met, a release warning may be raised. The release warning KPI may enumerate these warnings, and a monitoring element 416 may be provided to track the release warning KPI.

In some embodiments, the monitoring element 416 associated with the release warnings may continue to exist and be monitored within the production phase of the software distribution cycle 300. That is to say that when the release combination 102 has been deployed to customers, monitoring may continue with respect to the performance of the release combination 102. Since, in some embodiments, the release combination 102 runs on application servers (such as application server 115 of FIG. 2) agents such as agents 257 (see FIG, 2) may continue to run and provide information related to the release combination 102 in production. This production performance information can be utilized in several ways. In same embodiments, the production performance information may be used to determine if the release has met its release requirements 256 (see FIG. 2) with respect to the release combination 102 in production. As an example, one requirement of a release combination 102 may be to reduce response time for a particular API below one second. This requirement may be provided as a performance template, may be formalized within a monitoring element 416 of a release structure 402 that corresponds to the release combination 102, and may be tracked through the quality assessment phase 320 of the software distribution cycle 300. Once released, the monitoring element 416 may still be used to confirm that the production performance information of the release combination 102 continues to meet the requirement in production. In some embodiments, a developer of a particular component of the release combination 102 may define a performance template for a monitoring element 416 that validates the performance of the particular component during the development phase 310 and/or the quality assessment phase 320. In some embodiments, the same monitoring element 416 provided by the developer may allow the performance template to continue to be associated with the release combination 102 and be used during the production phase 330. In other words, components utilized during validation phases of the software distribution cycle 300 may continue to be used during the production phase 220 of the software distribution cycle 300.

As another example, a requirement for a new release combination 102 may be based on the performance of prior release combinations 102, as determined by the production performance information of the prior release combinations 102. The requirement for the new release combination 102 may specify, for example, a ten percent reduction in response time over a prior release combination 102. The production performance information for the prior release combination 102 can be accessed, including performance information after the prior release combination 102 has been deployed to a customer, and an appropriate requirement target can be calculated based on actual performance information from the prior release combination 102 in production. That is to say that a performance requirement for a new release combination 102 may be made to meet or exceed the performance of a prior release combination 102 in production, as determined by monitoring of the prior release combination 102 in production.

Another KPI to be monitored may include code coverage of the code associated with the release combination 102. In some embodiments, the code coverage may represent the amount of new code (e.g., newly created code) and/or existing code within a given release combination 102 that has been executed and/or tested. The code coverage KPI may provide a representation of the amount of the newly created code and/or total code that has been validated. In some embodiments, a code coverage value of 75% may mean that 75% of the newly created code in the release combination 102 has been executed and/or tested. In some embodiments, a code coverage value of 65% may mean that 65% of the total code in the release combination 102 has been executed and/or tested. A monitoring element 416 may be provided to track the code coverage KPI.

Another KPI that may be represented by a monitoring element 416 includes performance test results. In some embodiments, the performance test results may indicate a number of performance tests that have been executed successfully against the software artifacts 104 of the release combination 102. For example, a performance test result value of 80% may indicate that 80% of the performance tests that have been executed were executed successfully. The performance test results KPI may provide an indication of the relative performance of the release combination 102 represented by the release structure 402. A monitoring element 416 may be provided to track the performance test results. In some embodiments, failure of a performance test may result in the creation of a defect against the release combination 102. In some embodiments, the performance test results KPI may include a defect arrival rate for the release combination 102.

Another KPI that may be represented by a monitoring element 416 includes security vulnerabilities. In some embodiments, a security vulnerabilities score may indicate a number of security vulnerabilities identified with the release combination 102. For example, the development code of the release combination 102 may be scanned to determine if particular code functions and/or data structures are used which have been determined to be risky from a security standpoint. In another example, the running applications of the release combination 102 may be automatically scanned and tested to determine if known access techniques can bypass security of the release combination 102. The security vulnerability KPI may provide an indication of the relative security of the release combination 102 represented by the release structure 402. A monitoring element 416 may be provided to track the number of security vulnerabilities.

Another KPI that may be represented by a monitoring element 416 includes application complexity of the release combination 102. In some embodiments, the complexity of the release combination may be based on a number of software artifacts 104 within the release combination 102. In some embodiments, the complexity of the release combination may be determined by analyzing internal dependencies of code within the release combination 102. A dependency in code of the release combination 102 may occur when a particular software artifact 104 of the release combination 102 uses functionality of, and/or is accessed by, another software artifact 104 of the release combination 102. In some embodiments, the number of dependencies may be tracked so that the interaction of the various software artifacts 104 of the release combination 102 may be tracked. In some embodiments, the complexity of the underlying source code of the release combination 102 may be tracked using other code analysis techniques, such as those described in in co-pending U.S. patent application Ser. No. ______ to Uri Scheiner and Yaron Avisror entitled “AUTOMATED SOFTWARE DEPLOYMENT AND TESTING” (Attorney Docket No. 1443-180278). A monitoring element 416 may be provided to track the complexity of the release combination 102.

As illustrated in FIG. 4, the various elements of the release data model 400 may access, and/or be accessed by, various data sources 420. The data sources 420 may include a plurality of tools that collect and provide data associated with the release combination 102. For example, the release management system 110 of FIG. 2 may provide data related to the release combination 102. Similarly, test system 122 of FIG. 2 may provide data related to executed tests and/or test results. Also, development system 120 of FIG. 2 may provide data related to the structure of the code of the release combination 102, and interdependencies therein. It will be understood that other potential data sources 420 may be provided to automatically support the various data elements (e.g., 404, 405, 406, 408, 410, 412, 414, 416) of the release data model 400.

As described with respect to FIG. 4, the approval element 408 of the release structure 402 may manage approvals for particular aspects of the release combination 102, including promotion between phases (e.g., promotion from development phase 310 to quality assessment phase 320 of FIG. 3). In some embodiments, the approval elements 408 can be automatically created and/or satisfied (e.g., approved) based on data provided by the monitoring elements 416 of the release structure 402. In other words, the data provided by the monitoring elements 416 may be used to promote a release combination 102 automatically. The use of automatic approval may allow for more efficient release management, because the software development process does not need to wait for manual approvals. In some embodiments, the use of objective data provides for a more repeatable and predictable process based on objective data, which can improve the quality of developed software.

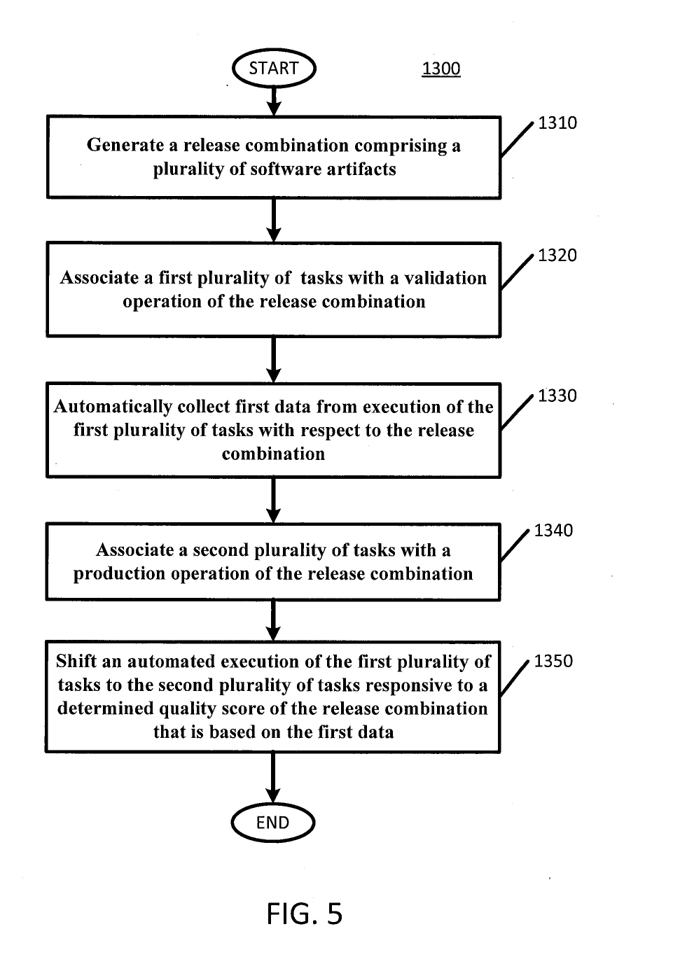

FIG. 5 is a flowchart of operations 1300 for managing the automatic distribution of a release combination 102, according to embodiments described herein. These operations may be performed, for example, by the quality scoring system 105 and/or the release management system 110 of FIG. 2, though the embodiments described herein are not limited thereto. One or more blocks of the operations 1300 of FIG. 5 may be optional.

Referring to FIG. 5, the operations 1300 may begin with block 1310 in which a release combination 102 is generated that includes a plurality of software artifacts 104. The release combination 102 may be defined as a particular version that, in turn, includes particular versions of software artifacts 104, such as that illustrated in FIG. 1B. The definition of the release combination 102 may be stored, for example, as part of the release definitions 250 of the release management system 110. The release combination 102 may represent a collection of software that can be installed on a computer system (e.g., an application server 115 of FIG. 2) to execute tasks when accessed by a user. In some embodiments, the generation of the release combination 102 may include the instantiation and population of a release structure 402 for the release combination 102. The release structure 402 for the generated release combination 102 may include approval elements 408 and monitoring elements 416, as described herein. In some embodiments, the monitoring elements 416 may indicate data (e.g., KPIs) that may be monitored and/or collected for the release combination 102.

The operations 1300 may include block 1320 in which a first plurality of tasks may be associated with a validation operation of the release combination 102. The validation operation may be, for example, the quality assessment phase 320 of the software distribution cycle 300. The first plurality of tasks may include the quality assessment tasks performed during the quality assessment phase 320 to validate the release combination 102. In some embodiments, the first plurality of tasks may be automated.

The operations 1300 may include block 1330 in which first data is automatically collected from execution of the first plurality of tasks with respect to the release combination 102. In some embodiments, the first data may be automatically collected by the monitoring elements 416 of the release structure 402 associated with the release combination 102. As noted above, the release structure 402 that corresponds to the release combination 102 may include monitoring elements 416 that define, in part, particular KPIs associated with the release combination 102. The first data that is collected may correspond to the KPIs of the monitoring elements 416. In some embodiments, the first data may include performance information (e.g., release warning KPIs) that may be collected by the performance engine 239 of the quality scoring system 105 (see FIG. 2). In some embodiments, the first data may include test information (e.g., performance test result KPIs and/or security vulnerability KPIs) that may be collected by the testing engine 215 of the test system 122 (see FIG. 2). In some embodiments, the first data may include software artifact information (e.g., code coverage KPIs and/or application complexity KPIs) that may be collected by the source control engine 207 of the development system 120 (see FIG. 2).

The operations 1300 may include block 1340 in which a second plurality of tasks may be associated with a production operation of the release combination 102. The production operation may be, for example, the production phase 330 of the software distribution cycle 300. The second plurality of tasks may include the production tasks performed during the production phase 330 to move the release combination 102 into customer use. In some embodiments, the second plurality of tasks may be automated.

The operations 1300 may include block 1350 in which an execution of the first plurality of tasks is automatically shifted to the second plurality of tasks responsive to a determined quality score of the release combination 102 that is based on the first data. Shifting from the first plurality of tasks to the second plurality of tasks may involve a promotion of the release combination 102 from the quality assessment phase 320 to the production phase 330 of the software distribution cycle 300. As discussed herein, promotion from one phase of the software distribution cycle 300 to another phase may involve the creation of approval records. As further discussed herein, a release structure 402 associated with the release combination 102 may include approval elements 408 (see FIG. 4) that track and/or facilitate the approvals used to promote the release combination 102 between phases of the software distribution cycle 300. In some embodiments, automatically shifting the execution of the first plurality of tasks to the second plurality of tasks may include the automated creation and/or update of the appropriate approval elements 408 of the release data model 400. The automated creation and/or update of the appropriate approval elements 408 may trigger, for example, the promotion of the release combination 102 from the quality assessment phase 320 to the production phase 330 (see FIG. 3).

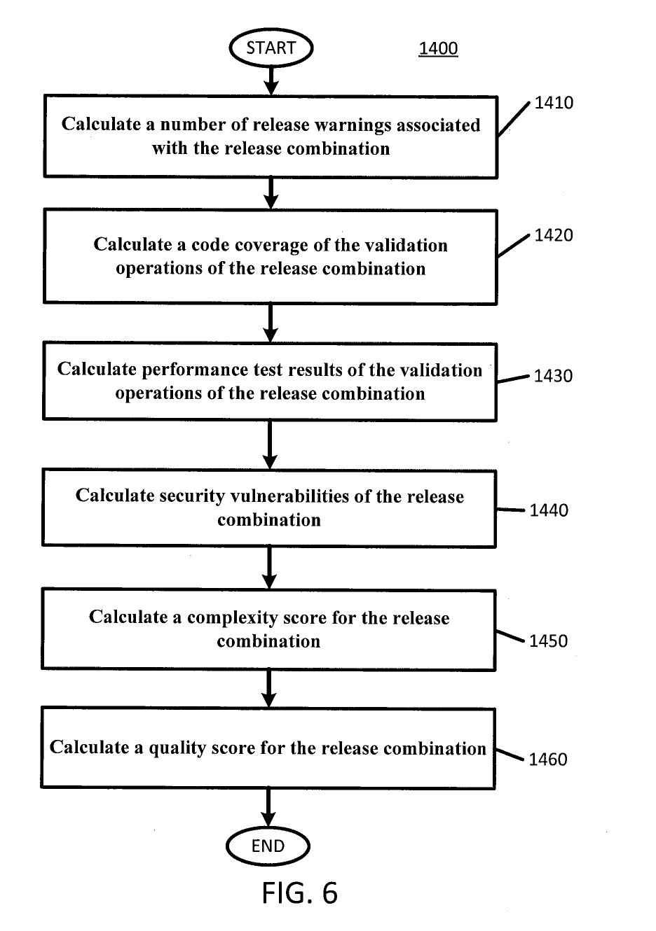

As indicated in block 1350, the automatic shift from the first plurality of tasks to the second plurality of tasks may be based on a quality score. In some embodiments, the quality score may be based, in part, on KPIs that may be represented by one or more of the monitoring elements 416. FIG. 6 is a flow chart of operations 1400 for calculating a quality score for a release combination 102, according to embodiments described herein. One or more blocks of the operations 1400 of FIG. 6 may be optional. In some embodiments, calculating the quality score may be performed by the quality scoring system 105 of FIG. 2.

Referring to FIG. 6, the operations 1400 may begin with block 1410 in which a number of release warnings may be calculated for the release combination 102. As discussed herein with respect to FIGS. 2 and 4, monitoring elements 416 may be associated with agents 257 included in software artifacts 104 of the release combination 102. The agents 257 may provide performance data with respect to the release combination 102 in the form of release warnings. The release warnings may indicate when particular operations of the release combination 102 are not performing as intended, such as when an operation takes too long to complete. The release warnings may be collected, for example by the performance engine 239 of the quality scoring system 105. The number of release warnings may, in some embodiments, be retrieved as a release warning KPI from a monitoring element 416 for release warnings included in the release structure 402 associated with the release combination 102.

The operations 1400 may include block 1420 in which a code coverage of the validation operations of the release combination 102 is calculated. The code coverage may be determined from an analysis of the validation operations of, for example, the testing engine 215 of the test system 122 of FIG. 2. The code coverage may indicate an amount of the code of the release combination 102 that has been tested by the test system 122. The code coverage value may, in some embodiments, be retrieved as a code coverage KPI from a monitoring element 416 for code coverage included in the release structure 402 associated with the release combination 102.

The operations 1400 may include block 1430 in which performance test results of the validation operations of the release combination 102 are calculated. The performance test results may be determined from an analysis of the result of performance tests performed by, for example, the testing engine 215 of the test system 122 of FIG. 2. The performance test results may indicate the number of performance tests performed by the test system 122 that have passed. The performance test results may, in some embodiments, be retrieved as a performance test result KPI from a monitoring element 416 for performance tests included in the release structure 402 associated with the release combination 102. In some embodiments, the performance test results may include a defect arrival rate for defects discovered during the validation operations.

The operations 1400 may include block 1440 in which a number of security vulnerabilities of the release combination 102 are calculated. The number of security vulnerabilities may be determined from security scans performed by, for example, the testing engine 215 of the test system 122 and/or the development tools 205 of the development system 120 of FIG. 2. The number of security vulnerabilities may indicate a vulnerability of the release combination 102 to particular forms of digital attack. The number of security vulnerabilities may, in some embodiments, be retrieved as a security vulnerability KPI from a monitoring element 416 for security vulnerabilities included in the release structure 402 associated with the release combination 102.

The operations 1400 may include block 1450 in which a complexity score of the release combination 102 is calculated. The complexity score may be determined from an analysis of the interdependencies of the underlying software artifacts 104 of the release combination 102 that may be performed by, for example, the development tools 205 and/or the source control engine 207 of the development system 120 of FIG. 2. The complexity score may indicate a measure of complexity and, thus, potential for error, in the release combination 102. The complexity score may, in some embodiments, be retrieved as a complexity score KPI from a monitoring element 416 for complexity included in the release structure 402 associated with the release combination 102.

The operations 1400 may include block 1460 in which a quality score for the release combination 102 is calculated. The quality score may be based on a weighted combination of at least one of the KPIs associated with the number of release warnings, the code coverage, the performance test results, the security vulnerabilities, and/or the complexity score for the release combination 102, though the embodiments described herein are not limited thereto. It will be understood that the quality score may be based on other elements instead of, or in addition to, the components listed with respect to FIG. 6.

The quality score may be of the form:

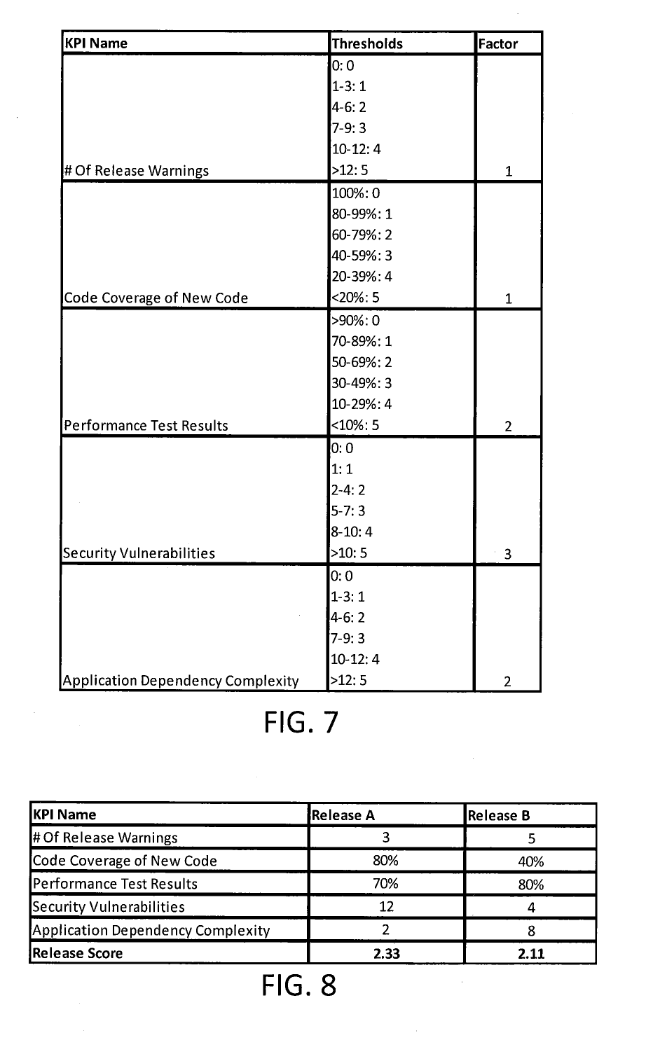

QS=(W_{KPI1}N_{KPI1}+W_{KPI2}N_{KPI2}+W_{KPI3}N_{KPI3}+W_{KPI3}N_{KPI3}+W_{KPI3}N_{KPI3}+W_{KPIn}N_{KPIn})/(N_{KPI1}+N_{KPI2}+N_{KPI3}+N_{KPI4}+N_{KPI5}+N_{KPIn})

where W_{KPIn} represents a weight factor given for a particular KPI and N_{KPIn} represents a numerical value given to a particular KPI. Since the KPIs include different types of native values (e.g., percentages vs. integral numbers), the KPIs may first be normalized to determine the numerical value. FIG. 7 is a table including a collection of KPI values with example thresholds and weight factors, according to embodiments described herein. As illustrated in FIG. 7, particular KPIs may be normalized to have a particular threshold value depending on their native value. For example, a release warning KPI may be itemized by a number of release warning received. The numerical value given to the release warning KPI may be normalized to be based on the number of release warnings. For example, no release warnings (0) may be associated with a numerical value (represented as a threshold in FIG. 7) of 0. If four to six (4-6) release warnings are received, the release warning KPI may be given a numerical value of 2, and so on. Code coverage may be treated similarly. For example, if code coverage is 100%, the numerical value assigned to the code coverage KPI may be 0. If the code coverage is between 60% and 79%, the code coverage KPI may be assigned a numerical value of 2. FIG. 7 illustrates other KPI values and the numerical values that may be assigned based on the respective underlying KPI value. For example, the performance test result KPI may be normalized based on the percentage of successfully completed tests, the security vulnerability KPI may be normalized based on the number of security vulnerabilities found, the application dependency complexity (e.g., complexity score) KPI may be based on the number of interdependent elements of the release combination 102, and so on. The thresholds provided in FIG. 7 are examples only, and the embodiments described herein are not limited thereto. Also, FIG. 7 illustrates an embodiment in which a lower score indicates higher quality (e.g., lower is better), but the embodiments described herein are not limited thereto. In some embodiments, the higher the quality score, the higher the quality of the underlying release combination 102.

As described above, each of the KPI values may also be associated with a weight factor (indicated as a “Factor” in FIG. 7). The weight factor may indicate a relative importance of the KPI to the quality score for the release combination 102. The weight factors illustrated in FIG. 7 are examples only, and the embodiments described herein are not limited thereto. In some embodiments, the weight factors may be different than those illustrated in FIG. 7.

Once the numerical values and weight factors for the KPIs have been defined, and the underlying KPI values have been calculated, a quality score may be generated. As indicated above, the quality score may be a weighted sum of the various normalized KPI values. For example, if a release combination 102 has five release warnings, has 82 percent code coverage, has passed 85% of the performance tests, has one identified security vulnerability, and has eight interdependencies within the release combination 102, the quality score, based on the example thresholds and weight factors of FIG. 7 would be:

QS=(2(1)+1(1)+1(2)+1(3)+3(2))/(1+1+2+3+2)=1.55

Referring back to FIG. 5, the quality score calculated in block 1460 of FIG. 6 may be compared against a predetermined threshold to determine if a given release combination 102 has a high enough quality score to be promoted to a next phase in the software distribution cycle 300. For example, the calculated quality score may be compared to a predetermined threshold defined as part of the release data model 400. If the calculated quality score is less than the predetermined threshold, the present tasks being performed on the release combination 102 (e.g., quality assessment tasks) may continue. If the calculated quality score equals or exceeds the predetermined threshold, the release combination 102 may be automatically promoted to the next phase of the software distribution cycle 300 (e.g., from the quality assessment phase to the production phase). In some embodiments, automatic promotion of the release combination 102 may include the automatic entry of an approval element 408 (see FIG. 4) with respect to the release combination 102. The automatic approval element 408 may include, for example, the calculated quality score. The automatic approval of the promotion may reduce overhead and resources by not requiring the manual intervention of a user.

The use of the quality score provides several technical benefits. For example, the calculated quality score may assist software development entities to evaluate whether a given release combination 102 is ready for production deployment. For a given release combination, the quality score may assist in determining where the risk lies for a given release combination 102. For example, the weighted numerical values may assist developers in understanding whether code coverage for the release combination 102 is too low (e.g., the validation efforts have not substantively touched the new code changes), whether the test results are low (e.g., a low success rate and/or fewer tests attempted), whether the release combination 102 is too complex and, potentially, fragile, and/or whether security vulnerabilities were found in the release combination 102 and were not resolved. Thus, the use of the weighted quality score may allow for improved technical content and a higher quality of function in the released software. In some embodiments, the use of the quality score and/or the release data model may enable the process of releasing software to be easily repeatable across multiple software release combinations 102 of varying content. This can allow the release process to easily scale within an enterprise in a content-neutral fashion. For example, the decision to release a software combination 102 may be objectively made without having to spend extensive amounts of time understanding the content and software changes that are a part of the release combination 102. This decision-making tool allows the release combination 102 to be reviewed and released in an objective way that was not previously possible.

In addition to determining the readiness of a particular release combination 102, the quality score may also allow for the comparison of one release combination 102 to another. FIG. 8 is a table including an example in which a first release combination Release A is compared to a second release combination Release B, according to embodiments described herein. The use of the normalized score allows for one release combination 102 to be compared to another in a normalized way that incorporates a number of different and varying inputs. For instance, as illustrated in FIG. 8, Release B can be seen to be slightly improved over Release A (a quality score of 2.11 vs. 2.33). It should be noted that the relative quality scores for the two release combinations 102 reflect the weighting of the various KPIs as illustrated in FIG. 7. If the weighting of a particular KPI is changed, the quality score may change. For instance, referring to FIG. 7, the example weight factor for the security vulnerability KPI is relatively high compared to the other KPIs. This reflects a choice of with respect to release management as to the relative importance of security to software releases. As a result, the higher number of security vulnerabilities in Release A negatively impacts its quality score in relation to Release B. In an example in which, for example, the weight factors of KPIs were changed (e.g., the weight factor of the code coverage KPI was increased while the weight factor of the security vulnerability KPI was decreased) the quality scores for the two release combinations 102 may be different, and the comparison result may be altered. Thus, the weighting of the KPIs allows the user of the release data model 400 to control the priorities of a release combination 102, and further control promotion of the release combination 102 through the software distribution cycle 300, based on the areas of most importance to the user. In some embodiments, a release combination 102 (e.g. Release A) that is currently in a validation phase (e.g., Quality Assessment Phase 320 of FIG. 3) may be compared to another release combination 102 (e.g., Release B) that is in production.

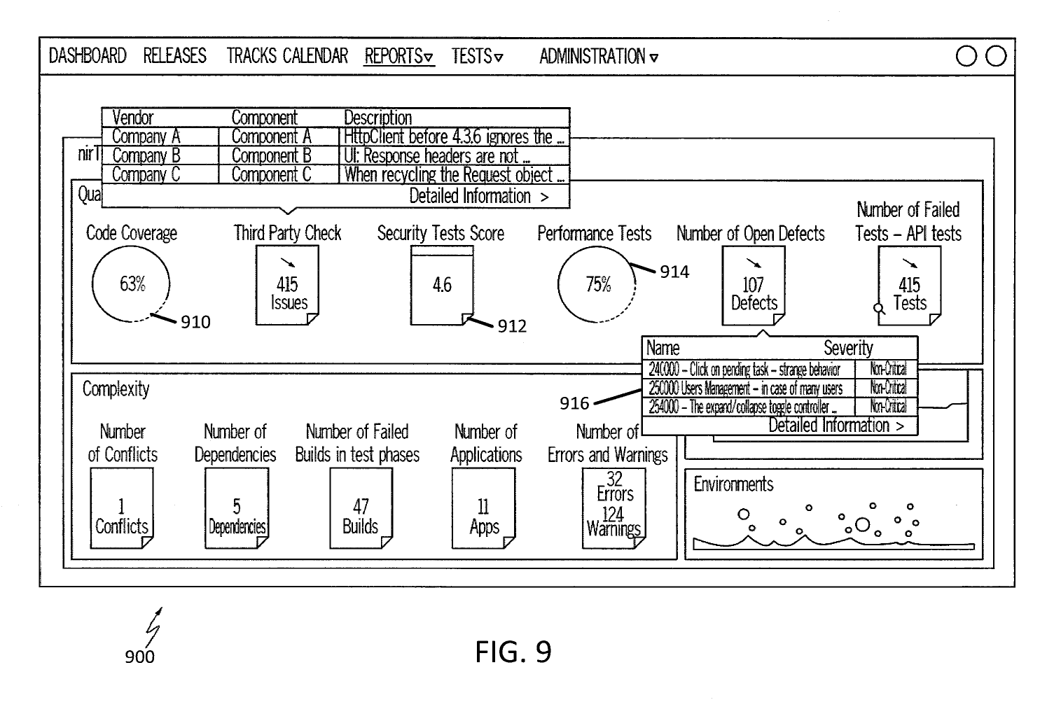

The embodiments as described herein allow for more accurate tracking of a release combination 102 through the software distribution cycle 300. In some embodiments, the data collected as part of the tracking may be provided to a user of the system (e.g., through a management client device 144 of FIG. 2). FIG. 9 is an example user interface illustrating an example dashboard 900 that can be provided to facilitate analysis of the release combination 102, according to embodiments described herein. The dashboard 900 may be provided as part of a graphical user interface displayed on a computing device (e.g., management client device 144 of FIG. 2). The dashboard 900 may include representations for one or more of the KPIs being monitored for a given release combination 102. For example, the dashboard 900 may display an icon for a code coverage KPI 910, an icon for a security vulnerability KPI 912, and/or an icon for a performance test result KPI 914. It will be understood that these are examples of icons that may be presented and that the number, and configuration, of information displayed to a user is not limited to the example of FIG. 9.

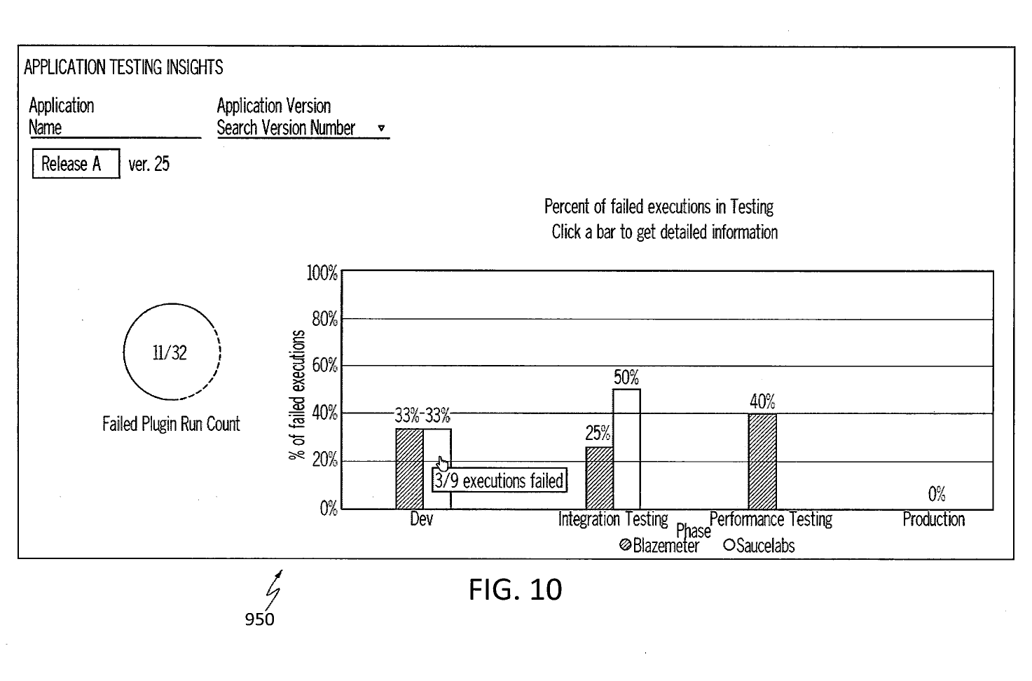

In some embodiments, hovering or otherwise interacting with a particular icon may provide additional drilldown information 916 that may provide additional data underlying the information in the icon. In some embodiments, additional drilldown information may be provided through additional graphical interfaces. FIG. 10 is an example user interface illustrating an example information graphic 950 that can be displayed to provide additional information related to the release combination 102, according to embodiments described herein. As illustrated in FIG. 10, graphical display interfaces can provide additional detail related to particular KPIs than can provide support for decision-making related to the release combination 102 during phases of the software distribution cycle 300.

As described herein, a release data model 400 may be provided, including a release structure 402 further including elements such as approval elements 408 and monitoring elements 416. The release data model 400 may improve the tracking of release combinations 102 moving through a software distribution cycle 300. The data of the release data model 400 may further be used to automatically promote the release combination 102 through tasks of the software distribution cycle 300 based on information determined from KPIs represented in the release data model 400.

Embodiments described herein may thus support and provide for the application to manage the production of release combinations 102 of software artifacts 104, which may be distributed as a software application. Some embodiments described herein may be implemented in a software distribution management application. One example software based pipeline management system is CA Continuous Delivery Director™, which can provide pipeline planning, orchestration, and analytics capabilities.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. As used herein, “a processor” may refer to one or more processors.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the FIGS. illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the FIGS. For example, two blocks shown in succession may, in fact, be executed substantially concurrently, or the blocks may sometimes be executed in the reverse order, depending upon the functionality involved. Although some of the diagrams include arrows on communication paths to show a primary direction of communication, it is to be understood that communication may occur in the opposite direction to the depicted arrows. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Other methods, systems, articles of manufacture, and/or computer program products will be or become apparent to one with skill in the art upon review of the embodiments described herein. It is intended that all such additional systems, methods, articles of manufacture, and/or computer program products be included within the scope of the present disclosure. Moreover, it is intended that all embodiments disclosed herein can be implemented separately or combined in any way and/or combination.

The terminology used herein is for the purpose of describing particular embodiments only and is not intended to be limiting to other embodiments. As used herein, the singular forms “a,” “an,” and “the” are intended to include the plural forms as well, unless the context clearly indicates otherwise. It will be further understood that the terms “comprises,” “comprising,” “includes,” and/or “including,” “have,” and/or “having” (and variants thereof) when used herein, specify the presence of stated features, integers, steps, operations, elements, and/or components, but do not preclude the presence or addition of one or more other features, integers, steps, operations, elements, components, and/or groups thereof. In contrast, the term “consisting of” (and variants thereof) when used in this specification, specifies the stated features, integers, steps, operations, elements, and/or components, and precludes additional features, integers, steps, operations, elements and/or components. Elements described as being “to” perform functions, acts and/or operations may be configured to or otherwise structured to do so. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the various embodiments described herein.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

When a certain example embodiment may be implemented differently, a specific process order may be performed differently from the described order. For example, two consecutively described processes may be performed substantially at the same time or performed in an order opposite to the described order.

Like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

In the drawings and specification, there have been disclosed typical embodiments and, although specific terms are employed, they are used in a generic and descriptive sense only and not for purposes of limitation, the scope of the disclosure being set forth in the following claims.

What is claimed is:

1. A method comprising:
generating a release combination comprising a plurality of software artifacts;
associating a first plurality of tasks with a validation operation of the release combination;
automatically collecting first data from execution of the first plurality of tasks with respect to the release combination;
associating a second plurality of tasks with a production operation of the release combination; and
shifting an automated execution of the first plurality of tasks to the second plurality of tasks based on a quality score of the release combination that is based on the first data.

2. The method of claim 1, wherein the first data comprises performance data that is collected based on a performance template associated with the release combination, and
wherein the performance template defines performance requirements of respective ones of the plurality of software artifacts.

3. The method of claim 2, wherein the performance data comprises runtime performance data reported by one of the plurality of software artifacts.

4. The method of claim 2, wherein the first data further comprises security data based on a security scan performed on the release combination.

5. The method of claim 2, wherein the first data further comprises complexity data based on an automated complexity analysis performed on the release combination.

6. The method of claim 5, wherein the automated complexity analysis is at least partially based on a number of dependencies between respective ones of the plurality of software artifacts of the release combination.

7. The method of claim 5, wherein the automated complexity analysis is at least partially based on a number of the plurality of software artifacts of the release combination.

8. The method of claim 2, wherein the first data further comprises defect arrival data associated with the first plurality of tasks.

9. The method of claim 2, wherein the first data further comprises an estimate of code coverage of the first plurality of tasks with respect to a combined code of the release combination.

10. The method of claim 1, wherein the quality score is based on a weighted sum of a plurality of key performance indicators.

11. The method of claim 10, wherein respective ones of the plurality of key performance indicators comprise a plurality of thresholds, each threshold associated with a value for the respective key performance indicator.

12. The method of claim 1, wherein the release combination is a first release combination comprising a first plurality of software artifacts,
wherein the quality score is a first quality score, and
wherein the method further comprises:
automatically collecting second data from execution of the second plurality of tasks with respect to the first release combination;
generating a second release combination comprising a second plurality of software artifacts after the execution of the second plurality of tasks with respect to the first release combination;
associating a third plurality of tasks with the validation operation of the second release combination;
automatically collecting third data from execution of the third plurality of tasks with respect to the second release combination;
associating a fourth plurality of tasks with the production operation of the second release combination; and
shifting an automated execution of the third plurality of tasks to the fourth plurality of tasks based on a second quality score of the second release combination that is based on at least one of the third data and the second data.

13. The method of claim 12, wherein the second quality score is further based on the first data.

14. The method of claim 12, wherein the second data that is automatically collected from the execution of the second plurality of tasks comprises first performance data of the first release combination in a production environment, and
wherein the third data that is automatically collected from the execution of the third plurality of tasks comprises second performance data of the second release combination in a test environment.

15. The method of claim 12, wherein shifting the automated execution of the third plurality of tasks to the fourth plurality of tasks comprises shifting the automated execution of the third plurality of tasks to the fourth plurality of tasks based on a comparison the first quality score of the first release combination to the second quality score of the second release combination.

16. The method of claim 12, wherein the second plurality of software artifacts comprises different versions of the first plurality of software artifacts.

17. The method of claim 1, wherein shifting the automated execution of the first plurality of tasks to the second plurality of tasks comprises shifting the automated execution of the first plurality of tasks to the second plurality of tasks based on a comparison of the quality score to a predetermined reference value.

18. The method of claim 1, wherein shifting the automated execution of the first plurality of tasks to the second plurality of tasks comprises an automatic creation of an approval record for the release combination.

19. A computer program product comprising:
a tangible non-transitory computer readable storage medium comprising computer readable program code embodied in the computer readable storage medium that when executed by at least one processor causes the at least one processor to perform operations comprising:
generating a release combination comprising a plurality of software artifacts;
associating a first plurality of tasks with a validation operation of the release combination;
automatically collecting first data from execution of the first plurality of tasks with respect to the release combination;
associating a second plurality of tasks with a production operation of the release combination; and
shifting an automated execution of the first plurality of tasks to the second plurality of tasks based on a quality score of the release combination that is based on the first data.

20. A computer system comprising:
a processor;
a memory coupled to the processor and comprising computer readable program code that when executed by the processor causes the processor to perform operations comprising:
generating a release combination comprising a plurality of software artifacts;
associating a first plurality of tasks with a validation operation of the release combination;
automatically collecting first data from execution of the first plurality of tasks with respect to the release combination;
associating a second plurality of tasks with a production operation of the release combination; and
shifting an automated execution of the first plurality of tasks to the second plurality of tasks based on a quality score of the release combination that is based on the first data.
